(19) United States
(12) Patent Application Publication
(10) Pub. No.: US 2012/0158300 A1
(43) Pub. Date: Jun. 21, 2012

(54) METHOD AND APPARATUS FOR PROVIDING USER INTERFACE FOR MAP APPLICATION IN USER EQUIPMENT

(76) Inventor: Yong-Jae KIM, Gyeonggi-do (KR)

(21) Appl. No.: 13/298,340

(22) Filed: Nov. 17, 2011

(30) Foreign Application Priority Data
Dec. 20, 2010 (KR) 10-2010-0130615

(51) Int. Cl. G01C 21/00

(52) U.S. Cl. 701/533

(57) ABSTRACT

Apparatus and method for providing a user interface for a map application in a user equipment. In order to provide the user interface, the background screen of the user interface may be formed from at least one image. Each image of the at least one image may represent a respective one of retrieved destination information. The user interface having the background screen formed from the at least one image may be displayed. A desired image may be selected from the at least one image of the displayed user interface, and a route to a desired destination corresponding to the selected desired image may be displayed.

### CROSS REFERENCE TO PRIOR APPLICATIONS

The present application claims priority under 35 U.S.C. §119 to Korean Patent Application No. 10-2010-0130615 (filed on Dec. 20, 2010), which is hereby incorporated by reference in its entirety.

### FIELD OF THE INVENTION

Apparatuses and methods consistent with the present invention relate to providing a user interface, and more particularly, to providing a user interface for a map application in a user equipment.

### BACKGROUND OF THE INVENTION

The development of Geographic Information System (GIS) technology and Location Based Service (LBS) technology linked with Global Positioning System (GPS) technology has led to the popularization of a service that can provide information about a route to a destination at anytime and anywhere, by detecting the current location of a person or an object and the surrounding information thereof

When a driver travels to an unfamiliar destination, the driver may receive a direction to the destination through a user equipment associated with GPS technology to acquire and display a traveling route to the destination and travel to the destination along the displayed traveling route. Such user equipment may provide the driver with various information for traveling, such as the moving direction of a vehicle, the distance to the destination, the current moving speed of the vehicle, the traveling route set by the driver before traveling, and the best route to the destination.

Such a user equipment may be mounted on a mobile unit such as a ship, an airplane or a car, to detect the current location and the moving speed of the mobile unit or determine the traveling route thereof. However, in order to receive information about a route to an unfamiliar destination during driving, a driver may be required to input the name of the destination by using a keyboard or an input unit in the user equipment. Also, in order to receive information about a route to a destination registered beforehand by the driver, a driver may be required to perform a complicating manual operation to search for a destination by navigating a user interface menu having a tree structure and textually-represented destination information. This may be an inconvenient procedure and burdensome to users, even potentially dangerous. Accordingly, there is a need for improving a user interface for a map application in a user equipment.

### SUMMARY OF THE INVENTION

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, a method for providing a user interface for a map application in a user equipment may improve user convenience.

In accordance with another aspect of the present invention, an apparatus for providing a user interface for a map application in a user equipment may improve user convenience.

In accordance with an embodiment of the present invention, a method may be provided for a user interface for a map application in a user equipment. In the method, destination information associated with the map application may be retrieved from a memory of the user equipment. A background screen of the user interface may be formed from at least one image. Each image of the at least one image may represent a respective one of the retrieved destination information. The user interface having the background screen formed from the at least one image representing the destination information may be displayed. A desired image may be selected from the at least one image of the displayed user interface. A route to a desired destination corresponding to the selected desired image may be displayed.

In order to form the background screen of the user interface, the background screen of the user interface may be divided into at least one sub-screen based on a number of the destination information. The at least one image representing the destination information may be extracted. The extracted at least one image may be arranged in the at least one sub-screen to form the background screen. The arranged at least one image may be mapped with corresponding destination information. The result of the mapping may be stored.

When dividing the background screen into the at least one sub-screen, the background screen may be divided into the at least one sub-screen such that each one of the at least one sub-screen has the same size or such that ones of the at least one sub-screen have varying sizes. Furthermore, the background screen may be divided into a number of sub-screens corresponding to the number of the destination information stored in the memory.

While arranging the extracted at least one image in the at least one sub-screen, at least one of a size and a position of each image of the extracted at least one image may be controlled according to a user preference associated with each of the destination information.

While displaying the route to the desired destination corresponding to the selected image, a selection input may be received for selecting the desired image from the background screen. Then, a destination information corresponding to the selected desired image may be extracted based on the stored result of the mapping. The map application may be executed to retrieve data for the route from a current location to the desired destination. The route to the desired destination may be displayed based on the retrieved data.

The at least one image representing the destination information may include at least one of an image that is captured by a user using a camera, an image showing a route to a destination that is provided by the map application, an image related to a destination that is acquired from a website, and an image of a text related to a destination.

Furthermore, the destination information corresponding to the at least one image may be automatically retrieved by extracting a location information embedded in the at least one image.

Information corresponding to the desired destination may be displayed while the route to the desired destination is displayed.

In accordance with another embodiment of the present invention, an apparatus may be provided for a user interface for a map application in a user equipment. The apparatus may include an input unit, a memory, a formation unit, and a display unit.

The input unit may be configured to receive an input from a user. The memory may be configured to store destination information. The formation unit may be configured to retrieve the destination information from the memory, and configured to form a background screen of the user interface from at least one image. Each image of the at least one image may represent a respective one of the retrieved destination information. The display unit may be configured to display the user interface having the background screen formed from the at least one image representing the destination information, and configured to display a route to a desired destination corresponding to an image selected from the displayed background screen formed from the at least one image.

The formation unit may be further configured to divide the background screen of the user interface into at least one sub-screen based on a number of the destination information stored in the memory, extract the at least one image, arrange the extracted at least one image in the at least one sub-screen to form the background screen, map the arranged at least one image with corresponding destination information, and store a result of the mapping in the memory.

The formation unit may be further configured to divide the background screen into the at least one sub-screen such that each one of the at least one sub-screen has the same size or such that ones of the at least one sub-screen have varying sizes. The formation unit may also be further configured to divide the background screen into a number of sub-screens corresponding to the number of the destination information stored in the memory.

Furthermore, at least one of a size and a position of each image of the extracted at least one image may be controlled according to a user preference associated with each of the destination information.

The at least one image representing the destination information may include at least one of an image that is captured by a user using a camera, an image showing a route to a destination that is provided by the map application, an image related to a destination that is acquired from a website, and an image of a text related to a destination.

The formation unit may be further configured to automatically retrieve the destination information corresponding to the at least one image by extracting a location information embedded in the at least one image.

The display unit may be further configured to display information corresponding to the desired destination while the route to the desired destination is displayed.

In accordance with still another embodiment of the present invention, a computer program product embodied on a computer-readable storage medium may be provided. When executed by a computer of a user equipment, the computer program product may cause the computer to perform a method including retrieving destination information associated with the map application from a memory of the user equipment, forming a background screen of the user interface from at least one image, displaying the user interface having the background screen formed from the at least one image representing the destination information, selecting a desired image from the at least one image of the displayed user interface, and displaying a route to a desired destination corresponding to the selected desired image. Each image of the at least one image may represent a respective one of the retrieved destination information.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a user equipment configured to provide a user interface for a map application, in accordance with an embodiment of the present invention;

FIG. 2 illustrates an example of using a user interface for a map application in a user equipment, in accordance with an embodiment of the present invention; and

FIG. 3 illustrates a method for providing a user interface for a map application in a user equipment, in accordance with an embodiment of the present invention.

FIG. 4 illustrates a method for setting up a background screen of a user interface for a map application in a user equipment, in accordance with an embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

In accordance with an embodiment of the present invention, a user equipment may set up a background screen of a user interface for a map application with a plurality of images each representing a respective one of destination information. When a user selects one of the images from the background screen of the user interface, the user equipment may retrieve data for a route to a desired destination corresponding to the selected image and display the route to the desired destination on a display unit. Accordingly, a user may conveniently and quickly retrieve directions to a destination where he/she wants to travel.

Such a background of a user interface for a map application may be referred to as a GPS wall, an active background, a live background, an active wallpaper, and/or a live wallpaper. Hereinafter, for convenience and ease of understanding, the term “GPS wall” will be used throughout the specification in order to describe any or all of the background, the active background, the live background, the active wallpaper, and the live wallpaper for a user interface for a map application in a user equipment. In general, the GPS wall may be a type of application that functions as a background image of a user interface and interacts with the user in response to a user action. For example, the GPS wall may be configured of a plurality of icons or images each associated with a set of events. When a user selects one of the icons or images in the GPS wall, the user equipment may perform a set of events associated with the selected icon or image.

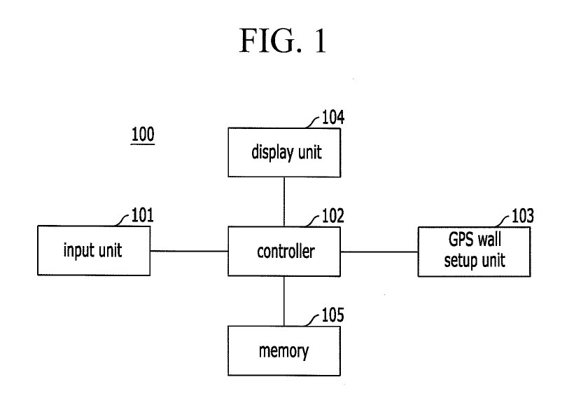

FIG. 1 illustrates a user equipment 100 configured to provide a GPS wall of a user interface for a map application, in accordance with an embodiment of the present invention. Examples of the user equipment may include a dedicated navigation device and a mobile device having a map and/or navigation application. A user may enable or access the GPS wall by flicking a home screen of the user equipment toward the left, right, up or down by using a finger or various types of pointing devices.

Referring to FIG. 1, the user equipment 100 may include an input unit 101, a controller 102, a GPS wall setup unit 103, a display unit 104, and a memory 105.

The input unit 101 may include or provide a user interface (UI) for receiving a user input from a user. The input unit 101 may include a touch screen in order to satisfy demands of expanding a display screen, making better use of a space, and improving design. When the user equipment 100 employs a touch screen, the input unit 101 may be integrally realized with the display unit 104. For example, the input unit 101 may be realized as a soft key type input unit on a display module of the user equipment 100.

The user input may include any action that generates a signal to invoke one or more functions of the user equipment. For example, the user input may be a control command or a function selection command for controlling general operations of the user equipment 100. The function selection command may be a command to invoke a GPS wall setup function. Furthermore, the user input may include a selection input for selecting an image from those displayed on the background screen of the GPS wall. For example, the user input may be a selection of a desired destination that a user desires to travel.

The input unit 101 may receive a user input for starting a map application. For example, a user may flick a home screen to the left, right, up or down by using a finger or various types of pointing devices to start a GPS wall of the user interface.

The input unit 101 may receive a user input for selecting one of the plurality of images disposed on sub-screens which are divided from the background screen of the GPS wall by the GPS wall setup unit 103.

The GPS wall setup unit 103 may set up a GPS wall based on destination information stored in the memory 105. For example, the GPS wall setup unit 103 may divide the background screen of the GPS wall into a plurality of sub-screens based on a number of destination information that is stored in the memory 105, extract at least one image representing the destination information, and arrange the extracted at least one image into the sub-screens.

For example, upon receiving a user input from the input unit 101, the GPS wall setup unit 103 may divide the background screen of the GPS wall into a plurality of sub-screens based on the number of the stored destination information. The GPS wall setup unit 103 may set up sizes of sub-screens differently according to user preference. The size of each of the extracted images may be to the same or different from the size of each of the sub-screens to be disposed on. If the size of a sub-screen is to the same as the size of an extracted image, the GPS wall setup unit 103 under the control of the controller 102 may arrange the extracted image on the sub-screen without changing its size. On the other hand, if the size of a sub-screen is different from the size of an extracted image, the GPS wall setup 103 under the control of the controller 102 may dispose the extracted image on the sub-screen at an adjusted size to correspond to the size of the sub-screen.

The extracted image may include an image that is captured by a user using a camera mounted on the user equipment, an image showing a route to a destination that is provided by the map application, an image related to a destination that is acquired from a web site, and/or an image of a text representing a destination.

The display unit 104 may display information generated during operations of the user equipment 100 and/or display results of the operations. For example, the display unit 104 may display a result of performing operations in each constituent element of the user equipment 100. The display unit 104 may display a plurality of images representing destination information stored in the memory 105. The display unit 104 may display a GPS wall formed or set up by the GPS wall setup unit 103. The display unit 104 may display information associated with destination information. The display unit 104 may display an operation status of the user equipment 100, such as a battery status, a signal intensity, a date, and/or a current time.

The display unit 104 may include a liquid crystal display (LCD), an organic light emitting display (OLED), or an electrophoretic display (EPD).

The memory 105 may store applications, programs, data, and/or information used by constituent elements of the user equipment 100. The memory 105 may also store destination information. Furthermore, the memory 105 may store images and/or information on mapping between the images and the destination information thereof. The memory 105 may store a GPS wall formed or set up by the GPS wall setup unit 103.

The memory 105 may provide stored information and data to the controller 102, the display unit 104, and/or the GPS wall setup unit 103, in response to requests therefrom. The memory 105 may include a plurality of sub-memories or be divided into a plurality of memories.

The memory 105 may include a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto. In accordance with an embodiment of the present invention, the user equipment 100 may interact with a web-based storage that performs the storage function of the memory 105.

The memory 105 may store a plurality of images each representing a respective one of destination information. For example, the images may include an image that is captured by a user using a camera mounted in the user equipment, an image showing a route to a destination that is provided by the map application, an image related to a destination that is acquired from a web site, and an image of a text representing a destination.

The controller 102 may perform operations for controlling constituent elements of the user equipment 100 including the input unit 101, the GPS wall setup unit 103, the display unit 104, and the memory 105. For example, the controller 102 may control the display unit 104 to display one or more images each representing destination information as a GPS wall of a user interface when the GPS wall setup unit 103 forms the GPS wall with images. The controller 102 may drive a map application to display a desired route corresponding to an image selected by a user from the GPS wall. Furthermore, the controller 102 may control the display unit 104 to display information associated with the destination and/or travel while displaying the route to the destination. For example, the information may include an estimated arriving time, moving direction, moving speed, etc.

The controller 102 may control the GPS wall setup unit 103 to arrange the images representing the destination information stored in the memory 105 on the sub-screens. If the size of a sub-screen is to the same as the size of an image, the controller 102 may control the GPS wall setup unit 103 to dispose the image on the sub-screen without changing its size. On the other hand, if the size of a sub-screen is different from the size of an image, the controller 102 may control the GPS wall setup unit 103 to dispose the image on the sub-screen at an adjusted size to correspond to the size of the sub-screen.

The controller 102 may detect correspondence between the position of an image and the position of a user selection on the GPS wall and determine a desired destination corresponding to the selected image. The controller 102 may retrieve data for a route to the destination and control the display unit 104 to display the route from the current location to the destination on the basis of the map application program.

In accordance with an embodiment of the present invention, a GPS wall may be configured of a plurality of images each representing a respective one of destination information. When a user selects an image displayed on the GPS wall, a user equipment may display a route to a desired destination corresponding to the selected image and/or display information related to the destination and/or travel route.

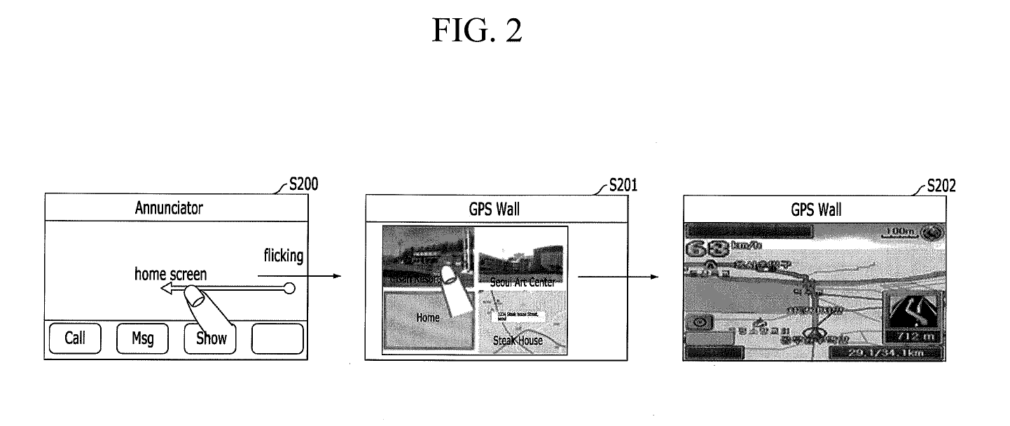

As described above, the GPS wall may be set up with images related to destination information stored in a memory. Hereinafter, examples of using the GPS wall formed with one or more images each representing a respective one of media contents, in accordance with an embodiment of the present invention, will be described with reference to FIG. 2.

FIG. 2 illustrates an example of using a GPS wall of a user interface for a map application in a user equipment, in accordance with an embodiment of the present invention.

Referring to FIG. 2, the user equipment 100 may display a home screen having a plurality of icons and menu keys on the display unit 104 and wait for a user input to be entered. The user equipment 100 may receive a user input for starting a GPS wall S200. The user input may be any action that generates a signal to invoke at least one function of the user equipment. For example, a user may flick a home screen toward the left, right, up or down by a finger or by various types of pointing devices.

Then, the user equipment 100 may display a background screen of the GPS wall having a plurality of images each representing a respective one of destination information S201. The background screen of the GPS wall may include at least one image each representing one of the destination information stored in the memory 105.

The background screen of the GPS wall may be divided into sub-screens. For example, the GPS wall setup unit 103 may divide the background screen of the GPS wall into a plurality of sub-screens based on the number of the destination information stored in the memory 105. The sub-screens may be the same or different from each other in terms of size and/or arrangement. For example, the sizes and/or arrangements of the sub-screens may vary according to the preference of a user.

The background screen of the GPS wall may include one or more images representing destination information. The images may include an image that is captured by a user using a camera mounted on the user equipment, an image showing a route to a destination that is provided by the map application, an image related to a destination that is acquired from a web site, and/or an image of a text representing a destination.

The user equipment 100 may receive a selection of a desired one of the displayed images S201. For example, a user may select an image of the displayed images by using a finger or any pointing device.

Then, a route from a current location to a desired destination corresponding to the selected image may be displayed S202. For example, the controller 102 may execute a map application to display a route to the desired destination corresponding to the selected image. For example, during the displaying of the route to the destination, the display unit 104 may display information related to the destination and/or travel, such as an estimated arrival time, current moving direction, current moving speed, etc.

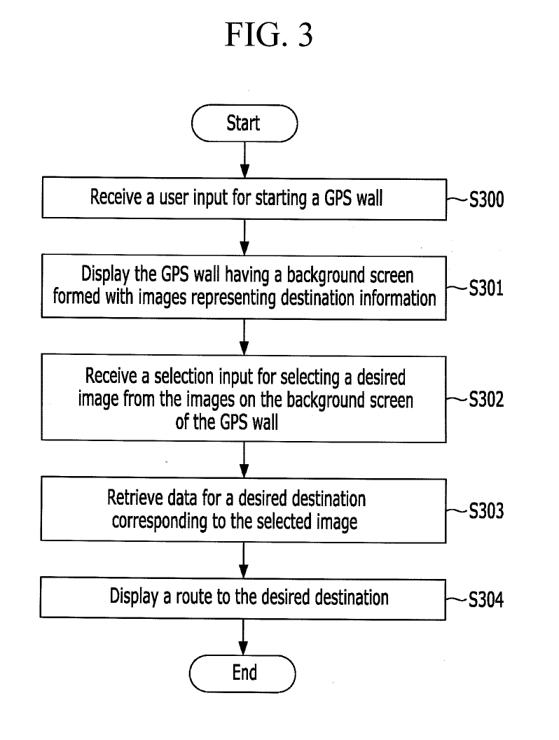

FIG. 3 illustrates a method for providing a GPS wall as a user interface for a map application in a user equipment, in accordance with an embodiment of the present invention.

Referring to FIG. 3, a user input for starting a GPS wall may be received S300. For example, the user may flick a home screen toward the left, right, up or down to start the GPS wall as a user interface for a map application.

When the user input for starting the GPS wall is received, a background screen of the GPS wall may be displayed, which is formed with one or more images each representing a respective one of destination information S301. For example, the images may include an image that is captured by a user using a camera mounted on the user equipment, an image showing a route to a destination that is provided by the map application, an image related to a destination that is acquired from a web site, and/or an image of a text representing a destination.

The user may select a desired image of the displayed images on the background screen of the GPS wall S302. For example, the user may input a selection of an image representing a destination, which he/she wants to travel, through the input unit 101 by using a finger or various types of pointing devices.

When the desired image is selected, data for a route to a desired destination corresponding to the selected image may be retrieved S303, and the route from a current location of the user to the desired destination may be displayed S304. For example, the controller 102 may detect correspondence between the position of the image and the position of the user selection on the GPS wall and determine a destination corresponding to the selected image. The controller 102 may execute a map application and retrieve data for a route to the destination and control the display unit 104 to display the route from the current location to the destination.

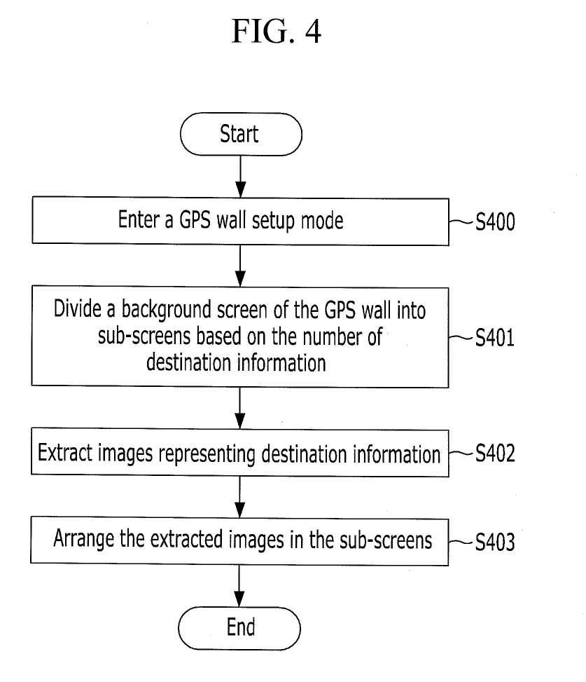

As described above, a background screen of a GPS wall may be set up with one or more images related to destination information stored in a memory of a user equipment. Hereinafter, an example of setting up a background screen of a GPS wall as a user interface for a map application, in accordance with an embodiment of the present invention, will be described with reference to FIG. 4.

FIG. 4 illustrates a method for setting up a GPS wall as a user interface for a map application in a user equipment, in accordance with an embodiment of the present invention.

Referring to FIG. 4, a GPS wall setup mode may be entered upon receiving a user input S400. For example, in accordance with an embodiment of the present invention, the input unit 101 of the user equipment 100 may display a home screen before setting up a background screen of a GPS wall. The home screen may be a default graphical user interface (GUI) that a user may interact with in order to enter inputs and/or requests. The GUI may output information in response to various user requests.

For example, before setting up the GPS wall as a user interface for the map application, the home screen may include a wallpaper such as a background image along with a plurality of icons and menu keys displayed on the wallpaper. The plurality of icons may include a home screen setting icon for invoking a home screen setting function.

When the user selects the home screen setting icon, the user equipment 100 may carry out a home screen setting function. In accordance with an embodiment of the present invention, by using the home screen setting function, the user may set up the home screen including setting up a GPS wall as a user interface for a map application

When the GPS wall setup mode is initiated, a background screen of the GPS wall may be divided into a plurality of sub-screens according to the number of the destination information S401. For example, upon receiving a user input for initiating the GPS wall setup mode, the GPS wall setup unit 103 under the control of the controller 102 may divide the background screen of the GPS wall into one or more sub-screens based on the number of the destination information stored in the memory 105. For example, the sizes of the sub-screens may be to the same or different from each other. For example, the number of sub-screens may be equal to the number of the destination information stored in the memory 105.

Then, each image representing a respective one of the destination information may be extracted S402. For example, the images may include an image representing a destination information, which is captured by an image device such as a camera mounted on the user equipment; an image related to a destination, which is acquired from a web site; an image of a text representing a destination; and an image showing a route to a destination, which is provided by the map application. For example, the user may select an image related to a destination according to his/her preference and/or interest.

Then, the extracted images may be arranged in the sub-screens S403. For example, the GPS wall setup unit 103 under the control of the controller 102 may arrange the extracted images representing the destination information in the sub-screens of the GPS wall. If the size of a sub-screen is to the same as the size of an image, the GPS wall setup unit 103 under the control of the controller 102 may dispose the image on the sub-screen without changing its size. On the other hand, if the size of a sub-screen is different from the size of an image, the GPS wall setup unit 103 under the control of the controller 102 may dispose the image on the sub-screen while adjusting the size of the image to correspond to the size of the sub-screen. After arranging the images on the sub-screens of the GPS wall, the positions of the arranged images with corresponding destination information may be mapped and the mapping results may be saved in the memory 105.

In accordance with embodiments of the present invention, when a user selects an image which is captured by a camera mounted on a user equipment as an image to be disposed on a sub-screen, destination information corresponding to the image may be automatically retrieved based on a location information embedded in the captured image.

In accordance with embodiments of the present invention, when a user selects a desired image displayed on a GPS wall, a user equipment may display a route from a current location to a desired destination corresponding to the selected image by executing a map application to display the desired route. Accordingly, the user may conveniently and quickly retrieve a direction to a destination where he/she wants to travel.

In accordance with embodiments of the present invention, the methods for setting up and providing a media wall as a user interface for media contents may be realized as a program and stored in a computer-readable recording medium such as a CD-ROM, a RAM, a ROM, floppy disks, hard disks, magneto-optical disks, and the like. Such can be easily implemented by those skilled in the art to which the present invention pertains, and thus further description will not be provided herein.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for providing a user interface for a map application in a user equipment, the method comprising:
retrieving destination information associated with the map application from a memory of the user equipment;
forming a background screen of the user interface from at least one image, wherein each image of the at least one image represents a respective one of the retrieved destination information;
displaying the user interface having the background screen formed from the at least one image representing the destination information;
selecting a desired image from the at least one image of the displayed user interface; and
displaying a route to a desired destination corresponding to the selected desired image.

2. The method of claim 1, wherein the forming the background screen of the user interface comprises:
dividing the background screen of the user interface into at least one sub-screen based on a number of the destination information;
extracting the at least one image;
arranging the extracted at least one image in the at least one sub-screen to form the background screen;
mapping the arranged at least one image with corresponding destination information; and
storing a result of the mapping.

3. The method of claim 2, wherein the dividing the background screen into the at least one sub-screen comprises:
dividing the background screen into the at least one sub-screen such that each one of the at least one sub-screen has a same size.

4. The method of claim 2, wherein the dividing the background screen into the at least one sub-screen comprises:
dividing the background screen into the at least one sub-screen such that ones of the at least one sub-screen have varying sizes.

5. The method of claim 2, wherein the dividing the background screen into the at least one sub-screen comprises:
dividing the background screen into a number of sub-screens corresponding to the number of the destination information stored in the memory.

6. The method of claim 2, wherein the arranging the extracted at least one image in the at least one sub-screen comprises:
controlling at least one of a size and a position of each image of the extracted at least one image according to a user preference associated with each of the destination information.

7. The method of claim 2, wherein the displaying the route to the desired destination corresponding to the selected image comprises:
receiving a selection input for selecting the desired image from the background screen;
extracting, based on the stored result of the mapping, a destination information corresponding to the selected desired image;
executing the map application to retrieve data for the route from a current location to the desired destination; and
displaying the route to the desired destination based on the retrieved data.

8. The method of claim 1, wherein the at least one image representing the destination information comprises at least one of an image that is captured by a user using a camera, an image showing a route to a destination that is provided by the map application, an image related to a destination that is acquired from a website, and an image of a text related to a destination.

9. The method of claim 1, further comprising:
automatically retrieving the destination information corresponding to the at least one image by extracting a location information embedded in the at least one image.

10. The method of claim 7, wherein information corresponding to the desired destination is displayed while the route to the desired destination is displayed.

11. An apparatus for providing a user interface for a map application in a user equipment, the apparatus comprising:
an input unit configured to receive an input from a user;
a memory configured to store destination information;
a formation unit configured to retrieve the destination information from the memory, and configured to form a background screen of the user interface from at least one image, wherein each image of the at least one image represents a respective one of the retrieved destination information; and
a display unit configured to display the user interface having the background screen formed from the at least one image representing the destination information, and configured to display a route to a desired destination corresponding to an image selected from the displayed background screen formed from the at least one image.

12. The apparatus of claim 11, wherein the formation unit is further configured to:
divide the background screen of the user interface into at least one sub-screen based on a number of the destination information stored in the memory;
extract the at least one image;
arrange the extracted at least one image in the at least one sub-screen to form the background screen;
map the arranged at least one image with corresponding destination information; and
store a result of the mapping in the memory.

13. The apparatus of claim 12, wherein the formation unit is further configured to divide the background screen into the at least one sub-screen such that each one of the at least one sub-screen has a same size.

14. The apparatus of claim 12, wherein the formation unit is further configured to divide the background screen into the at least one sub-screen such that ones of the at least one sub-screen have varying sizes.

15. The apparatus of claim 12, wherein the formation unit is further configured to divide the background screen into a number of sub-screens corresponding to the number of the destination information stored in the memory.

16. The apparatus of claim 12, wherein at least one of a size and a position of each image of the extracted at least one image is controlled according to a user preference associated with each of the destination information.

17. The apparatus of claim 11, wherein the at least one image representing the destination information comprises at least one of an image that is captured by a user using a camera, an image showing a route to a destination that is provided by the map application, an image related to a destination that is acquired from a website, and an image of a text related to a destination.

18. The apparatus of claim 11, wherein the formation unit is further configured to automatically retrieve the destination information corresponding to the at least one image by extracting a location information embedded in the at least one image.

19. The apparatus of claim 11, wherein the display unit is further configured to display information corresponding to the desired destination while the route to the desired destination is displayed.

20. A computer program product embodied on a computer-readable storage medium, which when executed by a computer of a user equipment, the computer program product causes the computer to perform a method, the method comprising:
retrieving destination information associated with the map application from a memory of the user equipment;
forming a background screen of the user interface from at least one image, wherein each image of the at least one image represents a respective one of the retrieved destination information;
displaying the user interface having the background screen formed from the at least one image representing the destination information;
selecting a desired image from the at least one image of the displayed user interface; and
displaying a route to a desired destination corresponding to the selected desired image.
